(19) United States
(12) Patent Application Publication
(10) Pub. No.: US 2005/0142292 A1
(43) Pub. Date: Jun. 30, 2005

(54) Intaglio printing process using radically curable printing inks

(75) Inventor: Helmut Schmidt, Konigstein (DE)

Correspondence Address: HARNESS, DICKEY & PIERCE, P.L.C., P.O. BOX 828, BLOOMFIELD HILLS, MI, 48303, US

(73) Assignee: FLINT INK CORPORATION, Ann Arbor (US)

(21) Appl. No.: 10/491,969

(22) PCT Filed: Oct. 16, 2002
(86) PCT No.: PCT/DE02/03914

(30) Foreign Application Priority Data
Oct. 19, 2001 (DE) 101 51 661.4

(51) Int. Cl. C08F 2/46

(52) U.S. Cl. 427/258; 427/487

(57) ABSTRACT

A method for rotogravure printing with radically curable polymerizable printing inks is described, in which said printing inks are cured by actinic radiation and, aside from the necessary additives and pigments, contain no organic solvents and no water as diluent or flow agent. The required flow properties of the inks for rotogravure printing are provided, aside from the use of common reactive diluents such as polymerizable acrylates, by the use of polymerizable vinyl ethers or hydroxyvinyl ethers.

The invention concerns a printing method with radical-polymerizable rotogravure printing inks, whose polymerization is initiated by actinic radiation. Common actinic radiation sources include, for example, UV lamps and lasers.

If high printing speeds are required in printing technique, the printing substrate can be printed on using a rotogravure printing method. In this method, a metallic printing cylinder comprising gravure cells that are engraved or etched into its surface is used. The gravure cells take up the printing ink which is then transferred by rolling the printing cylinder on the substrate and thereby emptying the gravure cells.

In the case of engraved gravure cells, the ink volume is determined by the gravure cell depth and base area, whereby the resulting thickness of the applied layer and the area of the print dot depend on both of these parameters for geometric reasons. This means that deeper gravure cells also have a larger base area and transfer a larger ink volume.

Similar relationships apply to etched gravure cells also, though with one essential difference as compared to engraved gravure cells: these gravure cells show a higher degree of emptying as compared to engraved gravure cells, since their tip has a rounded shape due to the etching.

Conventional printing ink systems for gravure printing consist of coloring agent, binding agent, solvent, and additives to improve the wetting and antifoaming properties. Aside from aromatic hydrocarbons such as toluene, the solvents used include ketones, alcohols, and esters.

For reasons of environmental protection, major efforts are being undertaken to prevent the emission of solvents in gravure printing and replace them by solvent-free ink systems or at least by ink systems with a reduced solvent content.

In the document, U.S. Pat. No. 5,429,841, it was proposed to partially replace by water the portions of organic solvents in gravure printing inks which are immiscible with water. However, the resulting oil/water emulsion still contains large quantities of organic solvents such that these cannot be considered to represent environmentally compatible printing inks.

According to EP-0686509, a solvent-free radiation-curable gravure printing ink with a viscosity of 100 mPas as is common for gravure printing methods can be provided by using low viscosity reactive diluents. These reactive diluents are incorporated into the binding agent matrix by means of an actinic radiation-induced polymerization. A UV-curable epoxide/reactive diluent system that can be cross-linked by cationic photopolymerization is proposed.

Providing for a viscosity as is common for gravure printing and using vinyl ether as the reactive diluent, it must be expected that the reactivity of the gravure printing ink is reduced too much and that substantial portions of the reactive diluent remain non-reacted after the polymerization process, which reduces the quality of the ink layer (e.g. the mechanical properties).

In the document, EP-0813976-B1, it was proposed to replace all solvent by water, whereby the binding agent is provided in the form of a dispersion or emulsion with acrylate or epoxide systems that is capable of polymerization after the water is evaporated. This ink system possesses the advantage that the gravure cell depth of the gravure printing cylinder that is required for the application of a water-dilutable UV ink system is the same as in the application of solvent-based gravure printing inks. However, there is a disadvantage in that, prior to actinic curing, the water must be removed completely by convection, IR or high frequency drying in order to obtain a stable ink film on the substrate.

In the publication, EP 0839667 A1, it was proposed to use a fraction of 3-25% volatile solvents in order to reduce the viscosity of the radiation-curable printing ink. This approach appears to be not feasible to obtain an environment-compatible printing ink system, since the use of large amounts of ink for printing involves the release of significant amounts of solvent into the atmosphere. Moreover, residual solvent may remain in the cured ink film after radiation curing, which may lead to a deterioration of the properties of the cured ink film.

Gravure printing inks usually require the viscosity to be low as compared to other printing ink systems and often are indicated to be in the range between 50 and 100 mPas. Aside from the epoxide system proposed in EP-0686509-A1 with its extremely high portion of reactive diluent, such low viscosities have been attained thus far only with conventional gravure printing inks, i.e. by means of the use of organic solvents, and in ink systems containing water-dilutable dispersions or emulsions as the binding agent component.

In the latter case, in which the organic solvent is all but replaced by water, very low viscosity printing ink systems can be attained relatively easily. Water, being used as the flow agent, has very low viscosity and determines the viscosity in multiple-phase systems of this type.

Two different cases must be distinguished if aqueous dispersions or emulsions are used to formulate gravure printing inks:
a) The use of dispersions and emulsions which dry by physical means is a common option. The drying process involves the evaporation of the flow agent, water, and the coalescence of the polymer particles. This process depends, amongst other factors, on the minimal film-forming temperature (MFT) of the binding agent system and the type of solvent, if a solvent is present.
b) If radiation-curable dispersions or emulsions are used as the major components of gravure printing inks, it is necessary to completely remove the flow agent water by evaporation prior to radiation curing. Radiation-induced polymerization becomes feasible only after complete drying, and then leads to the optimal development of the physical and chemical properties of the binding agent used. Physical drying of the ink system prior to radiation curing is quite difficult, requires elevated temperature and prolonged passage time in the drying zone. Often, radiation-curing ink systems of this type use PUR dispersions, which, in the best possible scenario, require a drying temperature of 300° C. at a drying zone passage time of one second.

In the use of water-dilutable radiation-curable systems, the gravure cell depth of the gravure printing cylinders is basically not different from the gravure cell depth that is common in solvent-containing ink systems. Consequently, the coloring agent concentration of the two systems is basically equal.

It is generally being presumed that ink systems for gravure printing should have ideal (Newtonian) flow properties. However, investigations with a high-pressure capillary viscometer have shown that rotogravure printing inks possess elastic properties, i.e. are pseudoplastic. It should also be noted that the shear rate of 10⁵-10⁷ sec⁻¹ of this printing method is very high, while the exposure time (time of gravure cell emptying) is short (1 μsec).

It is the object of the present invention to provide a method for rotogravure printing, in which a radiation-curable and environmentally compatible, i.e. solventfree, printing ink is used and in which the energy consumption of the drying process is not as high as in the application of a conventional water-dilutable radiation-curable ink system.

This objective is solved according to the invention by a printing method with the features of the appended claim 1. A corresponding gravure printing ink is the subject of claim 16.

Preferred embodiments and refinements of the present invention are evident from claims 2 to 15 and the following description.

A gravure printing ink with a radiation-curable ink system according to the invention that meets the requirements of gravure printing, especially as it concerns the low viscosity and high speed of printing (200 m/min), therefore comprises 20-75% (w/w), preferably 30-70% (w/w), of an actinic radiation-curable binding agent system, 2-25% (w/w), preferably 4-15% (w/w), of a vinyl ether, 0-45% (w/w) of a coloring agent, 2-15% (w/w), preferably 2-10% (w/w), of a radical photoinitiator, and 0-10% (w/w) additives.

It is preferable for the low molecular weight binding agent, which is provided in the form of oligoether, oligoester or urethane acrylates with a molecular weight of less than 1500, to be the main component of the radiation-curable binding agent system, whereby the viscosity at room temperature of any acrylate component thus used should preferably not exceed 500 mPas.

In a further embodiment, it is advantageous for a small fraction of prepolymers of the classes specified above with a higher molecular weight to be added in order to improve certain properties, such as the adherence to difficult substrates. Preferably, the fraction of these substances is less than 10% (w/w) in order not to increase the viscosity of the formulation to a significant extent.

According to another advantageous feature it is proposed that the printing ink contains a fraction of 0-75% (w/w) of a monomeric reactive diluent made of acrylic acid ester.

The group of reactive diluents includes monomeric acrylates, preferably with at least three acrylic acid ester groups, with a molecular weight of less than 400, and with a viscosity of less than 500 mPas.

Although monomers with only one acrylic acid ester group possess very low viscosity and a very good dilution effect, their reactivity as compared to the higher functional acrylic acid esters usually is much too low for their use in formulations for radiation-curable gravure printing.

The same basically applies-also to bifunctional acrylic acid esters, which usually are more reactive than monofunctional acrylates, but can be used in radiation-curable gravure printing inks only to a limited degree due to their reactivity. A pertinent example is 1,6-hexandiacrylic acid ethylester (HDDA), which has a remarkable dilution effect, but is preferably used comprising a maximal fraction of only 10% of the binding agent.

According to an advantageous feature it is proposed that the printing ink contains as low molecular weight binding agent one or several polyester acrylates, polyether acrylates including amino-modified types, or urethane acrylates with a molecular weight of less than 1500 and an acrylate functionality of at least 2, preferably 3 to 4.

According to another advantageous feature it can be considered that the printing ink contains a polyester acrylate or a polyether acrylate including an amino-modified type thereof, an epoxy acrylate or a polyurethane acrylate with a molecular weight above 1500 and an acrylate functionality of at least 2, preferably 3 to 4, whereby the fraction of these substances accounts for max. 10% (w/w) of the sum of binding agent and pigment.

Moreover, according to another advantageous feature it is proposed that the binding agent of the printing ink contains one or several of the following monomers: HDDA, di- or tripropyleneglycol diacrylate (DPGDA, TPGDA), trimethylolpropan di- or triacrylate (TMPDA, TMPTA) including their ethoxylated or propoxylated derivatives, pentaerythriol triacrylate (PETIA) or pentaerythriol tetraacrylate (PETTA) including their ethoxylated or propoxylated derivatives (such as PPTTA), ditrimethylolpropane tetraacrylate (DiTMPTTA), tris(2-hydroxyethyl)-isocyanurate triacrylate (THEICTA) and triacrylated glycerol (GPTA).

It is advantageous for the radiation curing of the printing method according to the invention to be performed in an inert atmosphere, in particular under a nitrogen or carbon dioxide atmosphere.

The essential component in the formulation of these printing inks is the vinyl ether, which reduces the viscosity of the radiation-curable ink system to the extent that the ink system can be used for gravure printing. Usually, both triethyleneglycol divinyl ether (DVE-3) or diethyleneglycol divinyl ether (DVE-2) can be used, whereby the latter reduces the viscosity slightly more than DVE-3, but has a clearly detectable inherent odor. Fractions of up to 11% of the total content of the formulation have no influence on the reactivity of the ink system. Evidently, higher vinyl ether fractions reduce the viscosity of the formulation even further, but should be avoided in order to prevent the generation of undesired reaction products during photopolymerization.

In general it is advantageous for the printing ink to contain as vinyl ether essentially di-vinyl ethers and vinyl ethers of higher functionality, in particular butanediol divinyl ether (BDDVE), diethyleneglycol divinyl ether (DVE-2), triethyleneglycol divinyl ether (DVE-3), cyclohexanedimethanol divinyl ether (CHDVE), hexanediol divinyl ether (HDDVE), diisopropylglycol divinyl ether (DPE-2), triisopropylglycol divinyl ether (DPE-3) or trimethylolpropane trivinyl ether (TMPTVE).

According to another feature it is advantageous for the printing ink to contain as vinyl ether monomeric vinyl ethers or hydroxyvinyl ethers, in particular 2-ethylhexyl vinyl ether (EHVE), octadecyl vinyl ether (ODVE), cyclohexyl vinyl ether (CVE), cyclohexanedimethanol monovinyl ether (CHMVE), dodecyl vinyl ether (DDVE) or diethyleneglycol monovinyl ether (MVE-2).

It is advantageous to use as pigments and photoinitiators the same commercial products as are in common use in UV-curable printing ink systems.

The printing may advantageously contain silanes at a fraction between 0.5 and 5% (w/w), preferably 1-3% (w/w), as an additive to improve the adherence to plastic films or metal foils. The group of additives comprises the common auxiliary agents, which are often of great significance in printing inks. This includes antifoaming agents, leveling agents, surface-active agents, and dispersion agents. A particularly group are the adherence improvers on the basis of silanes, which provide for crucial improvement of the adherence on certain substrates on which it is difficult to print. However, it must be considered in this context that the addition of silane compounds usually leads to a more or less pronounced increase in the viscosity, which may impair the printability of the gravure printing ink.

The following silanes are particularly preferred according to the invention: 3-aminopropyltrimethoxysilane, 3-aminopropyl-triethoxysilane, N-(n-butyl)-3-aminopropyltrimethoxysilane, polyglycolether-modified aminosilane, N-aminoethyl-3-aminopropylmethyldimethoxysilane, 3-aminopropylmethyldiethoxysilane, 3-ureidopropyltriethoxysilane, N-aminoethyl-3-aminopropyltrimethoxysilane, triamino-functional propyltrimethoxysilane, 3-(4,5-dihydroimidazolyl)-propyltriethoxysilane, 3-methacryloxypropyltrimethoxysilane, 3-glycidyloxypropyltrimethoxysilane, 3-glycidyloxypropyltriethoxysilane, 3-mercaptopropyltrimethoxysilane, polyethersilane, vinyltrichlorosilane, vinyltrimethoxysilane, vinyltriethoxysilane, vinyltris(2-methoxyethoxy)silane.

Usually, the use of vinyl ethers in radiation-curable gravure printing inks leads to printing inks which are well printable due to their rheological properties. Notwithstanding, it may be advantageous to heat the printing cylinder to a temperature of up to 50° C. to provide for a flawless printing image. This may be necessary if (i) the viscosity of the ink system increased by approx. 20-25% due to the addition of 1-3% silane adherence improver; (ii) the substrate to be printed on is not wetted without flaws; and (iii) the printing speed is very high (above 150 m/min).

According to the invention it is advantageous to keep the viscosity of the radiation-curable printing ink at a value of less than 305 mPas at 20° C. and a shear rate of D=100 sec⁻¹, and to have the viscosity reducible to a value of less than 100 mPas (D=100 sec⁻¹) by tempering the printing cylinder up to 50° C.

A major difference between the printing ink used according to the invention and the solvent-containing ink systems is that the radiation-curable systems contain no volatile components such as solvents. This has the following consequences for the printed dot: if the gravure cell depth of the printing cylinder were not adapted to the UV printing system, this would result in the printed ink film to be thicker as compared to the solvent-containing inks. However, usually this is not desirable and the gravure cell depth must therefore be reduced in the use of radiation-curable and solvent free inks. However, it is then also necessary to increase the coloring agent concentration as compared to the solvent-free ink systems.

The relationships for cone- and pyramid-shaped gravure cells of identical base area are described by

$${h}_{uv} = \frac{{c}_{L}}{{c}_{uv}} \cdot {h}_{L}$$

in which h is the gravure cell depth of solvent-based systems (subindex L), radiation-curable system (subindex UV), and c are the corresponding concentrations.

In this context, it must be considered that etched gravure cells, which are flatter and not as deep as engraved pointed gravure cells, are also easier to empty. Consequently, the use of etched gravure cells is advantageous in printing radiation-curable printing inks with no volatile components.

According to another advantageous feature it is proposed that the printing ink contains as a photoinitiator for the initiation of the radical polymerization one or several of the following compounds: 2-benzyl-2-dimethylamino-1-(4-morpholinophenyl)-butanone-1, phosphine oxides, in particular 2,4,6-trimethylbenzoyldiphenyl phosphine oxide, 2,4,6-trimethylbenzoylphenylethoxy phosphine oxide, bis(2,4,6-trimethylbenzoyl)-phenyl phosphine oxide, bis(2,6-dimethoxybenzoyl)-2,4,4-trimethyl-pentyl phosphine oxide, 1-hydroxy-cyclohexylphenylketone, 1-[4-(2-hydroxyethoxy)-phenyl]-2-hydroxy-2-methyl-1-propan-1-one, 2-hydroxy-2-methyl-1-phenylpropan-1-one, 1-hydroxycyclohexylphenylketone, 1-(4-isopropylphenyl)-2-hydroxy-2-methylpropan-1-one, 2-methyl-1-[4-(methylthio)phenyl]-2-morpholinopropanone-(1) or thioxanthone derivatives, in particular 2-isopropyl thioxanthone. According to an additional advantageous feature it may be provided that the printing ink contains derivatives including coinitiators, in particular amines.

The following examples of formulations with compositions according to the invention and their use are intended to illustrate the directive of the invention for technical actions.

Briefly summarized, the rotogravure printing method with radical-polymerizable printing inks can be described by saying that the printing inks cured by actinic radiation contain, aside from necessary additives and pigments, no organic solvents and no water as diluent or flow agent. The required flow properties of the inks for rotogravure printing are attained, aside from the use of common reactive diluents such as polymerizable acrylates, by the use of polymerizable vinyl ethers or hydroxyvinyl ethers.

A typical radiation-curable ink system according to the invention for gravure printing that meets the requirements with regard to low viscosity and high printing speed, has the composition shown in the following Table 1.

TABLE 1
General composition of a radiation-
curable UV gravure printing ink.

| Component | Fraction |
|---|---|
| Binding agent made of prepolymeric or | 20-75% |
| oligomeric acrylic acid esters | |
| (MW < 1500) | |
| Binding agent made of prepolymeric or | 0-10% |
| oligomeric acrylic acid esters | |
| (MW > 1500) | |
| Monomeric reactive diluent made of | 0-75% |
| acrylic acid ester | |
| Reactive diluent on the basis of a | 4-20% |
| vinyl ether | |
| Pigments | 0-45% |
| Photoinitiators | 2-15% |
| Additives (antifoaming agent, wetting | 1-10% |
| agent, and others) | |

### EXAMPLE 1

A radiation-curable blue gravure printing ink has for example the composition according to the following Table 2.

Radiation-curable blue gravure printing ink.

| Component | | Fraction |
|---|---|---|
| Laromer LR 8869 | 7) | 61.9% |
| Heliogenblau DD 7084DD | 7) | 18.2% |
| Irgacure 369 | 4) | 1.5% |
| Quantacure ITX (2-Isopropyl thioxanthone) | | 3% |
| Irgacure 907 | 4) | 2.4% |
| Flourstab UV 1 | 8) | 0.6% |
| Triethyleneglycol divinyl ether (DVE-3) | | 10% |
| Solsperse 32000 | 3) | 2.4% |

### EXAMPLE 2

An example of a radiation-curable white gravure printing ink is shown in Table 3.

TABLE 3
Radiation-curable white gravure printing ink.

| Component | | Fraction |
|---|---|---|
| Actilane 440 | 9) | 20% |
| Ebecryl PETIA | 1) | 20% |
| Rapicure (DVE-3) | 5) | 12.5% |
| Titanium dioxide | | 40% |
| Darocure 4265 | 4) | 7% |
| Solsperse 26000 | 3) | 0.5% |

### EXAMPLE 3

The influence of triethyleneglycol divinyl ether (DVE-3) and of the temperature on the viscosity, measured in mPas, of the formulation of Example 1 is shown in Table 4.

TABLE 4
Influence of DVE-3 and temperature on the viscosity.

| | Temperature | | | |
|---|---|---|---|---|
| | 25° C. | 30° C. | 35° C. | 40° C. |
| no DVE-3 | 360 mPas | 278 mPas | 208 mPas | 160 mPas |
| 10% DVE-3 | 178 mPas | 139 mPas | 109 mPas | 86 mPas |

### EXAMPLES 4 to 9

Table 5 shows various formulations of radiation-curable gravure printing inks and their viscosity, in mPas, at 23° C. and D=4600 sec⁻¹.

TABLE 5
Printing inks according to the invention.

| | Example No. | | | | | |
|---|---|---|---|---|---|---|
| Component | 4 | 5 | 6 | 7 | 8 | 9 |
| Craynor CN 922 6) | 15.5% | 14% | 15.5% | 14.5% | 14.5% | 14.6% |
| Ethoxylated | — | 14% | 15.6% | — | 14.6% | 14.6% |
| pentaerytriol tetra- | | | | | | |
| acrylate (PPTTA) | | | | | | |
| Pentaerytiol | — | — | — | — | 14.5% | — |
| triacrylate (PETIA) | | | | | | |
| Ebecryl 81 1) | 9.3% | 14% | 15.5% | 8.7% | — | 14.5% |
| Genomer 3364 2) | 21.8% | — | — | 20.4% | — | — |
| 1,6-Hexanediacrylic | — | 4.6% | — | — | — | — |
| acid ethylester (HDDA) | | | | | | |
| Triethyleneglycol | 11% | 11% | 11% | 11% | 11% | 11% |
| divinyl ether (DVE-3) | | | | | | |
| Solsperse 26000 3) | 0.4% | 0.4% | 0.4% | 0.4% | 0.4% | 0.4% |
| Darocure 4265 4) | 7% | 7% | 7% | 7% | 7% | 7% |
| Ratecure DMB 2) | — | — | — | 3% | 3% | 3% |
| Titanium dioxide A 1071 | 35% | 35% | 35% | 35% | 35% | 35% |
| Viscosity [η] | 140 mPas | 100 mPas | 130 mPas | 120 mPas | 160 mPas | 110 mPas |
| D = 4600 sec⁻¹ | | | | | | |

TABLE 5a
Manufacturer references in Tables 2, 3 and 5.

| | |
|---|---|
| 1) | UCB-Chemicals |
| 2) | Rahn (Zürich) |
| 3) | Avecia |
| 4) | Ciba Spezialitätenchemie |
| 5) | ISP |
| 6) | Cray Valley |
| 7) | BASF AG |
| 8) | Kromachem |
| 9) | Akzo Resins |

### EXAMPLE 10

The UV rotogravure printing ink according to example 1 was used for printing with the following printing unit: in an ink trough rotates a rubber roller whose surface is continuously wetted with the UV rotogravure printing ink. The rubber roller presses against a screened gravure forme roller revolving in the same direction. The screen ruling has four areas with 100, 120, 140, and 165 lines/cm and 11 different tonal values from light to solid and the gravure cell depths as shown in the table. The gravure cells have the shape of inverted pyramids. The base area is approx. 80×80 μm for 100 lines/cm full-tone and 40×40 μm for 165 lines/cm full-tone. Details are shown in Table 6.

TABLE 6
Gravure printing cylinder data.

| | Gravure | Gravure | Gravure |
|---|---|---|---|
| | cells | cells | cells |
| Screen | full-tone | medium- | light |
| (lines/cm) | (μm) | tone (μm) | (μm) |
| 100 | 26 | 16 | 6 |
| 120 | 22 | 14 | 6 |
| 140 | 18 | 12 | 6 |
| 165 | 16 | 10 | 6 |

The excess of ink is removed from the screen roller by a doctor blade. Subsequently, the printing image is transferred to the substrate. Polyethylene film was used as the substrate.

The printing speed was 100 m/min. At this speed, all ink areas (print densities between 2.1 and 1.5 depending on screening) were perfectly cured with a 308 nm excimer double-lamp system under an inert gas (nitrogen) atmosphere. The geometry of the ink dots for full-tone 165 lines/cm screen was a mean of 53×45 μm (base area of the gravure cells: 40×40 μm). The drying of the UV gravure printing ink was characterized by determining the substances capable of migrating (residual photoinitiator, residual monomers) under the following conditions: prints with an ink density of 2 were selected, extracted in acetonitrile in an ultrasonic bath for 10 min, and then subjected to HPLC analysis. Findings: residual monomers: =0.22 mg/dm², sum of photoinitiator and photoinitiator degradation products=0.43 mg/dm².

### EXAMPLE 11

The UV rotogravure printing ink of Example 1 was used for printing with the following printing unit: a pressure chamber doctor blade fits with the gravure forme roller and serves to force-fill its screened cells. The forme cylinder screening corresponds to Table 6. The excess of ink is doctored from it. Subsequently, the printing image is transferred to the substrate. Polyethylene film was used as the substrate. The printing speed was 100 m/min. At this speed, all ink areas (print densities between 2.0 and 1.5 depending on the screening) were thoroughly cured with a 308 nm excimer double-lamp system under an inert gas (nitrogen) atmosphere.

The geometry of the dots for full-tone 165 lines/cm was a mean of 55×48 μm (base area of the gravure cells: 40×40 μm). The drying of the UV gravure printing ink was characterized by determining the substances capable of migrating (residual photoinitiator, residual monomers) Findings: residual monomers: =0.20 mg/dm², sum of photoinitiator and photoinitiator degradation products=0.51 mg/dm².

### EXAMPLE 12

The UV gravure printing ink of Example 2 was used for printing on an M3300—Multi printing machine (Nilpeter) equipped with a gravure printing unit, at a temperature of 35° C. and with the use of an engraved forme cylinder (70 lines/cm, stylus angle: 120°) using both a buckled screen with an engraved depth of 33 μm and a finer screen with a depth of 26 μm. The substrates for printing were an LDPE/oPA laminate, printed on the LDPE side, and an oPP film. A corona pretreatment preceded the printing process in either case. The printing speed was 40 m/min. After printing, the UV curing was performed with a UV lamp (120 W/cm power).

The prints thus obtained were of good quality in full-tone and adhered to the films.

1. Rotogravure printing method for the printing on substrates, in which method an actinic radiation-curable printing ink is used, whereby the printing ink is applied to a printing substrate by means of an engraved or etched gravure printing cylinder whose cells for the uptake of printing ink are adapted to the printing image desired in the individual case, and the printing ink film is subsequently cured by actinic radiation under polymerization of the binding agent of the printing ink, wherein
the printing ink contains 20-75% (w/w) of an actinic radiation-curable binding agent system, 2-25% (w/w) of a vinyl ether, 0-45% (w/w) of a coloring agent, 2-15% (w/w) of a radical photoinitiator, and 0-10% (w/w) additives.

2. Method according to claim 1, wherein the printing ink contains a fraction of 20-75% (w/w) of low molecular weight binding agents consisting of prepolymeric or oligomeric acrylic acid esters with a molecular weight of less than 1500.

3. Method according to claim 1 wherein the printing ink contains a fraction of up to 10% (w/w) of high molecular weight binding agents consisting of prepolymeric or oligomeric acrylic acid esters with a molecular weight of more than 1500.

4. Method according to claim 1, wherein the printing ink contains a fraction of up to 75% (w/w) of a monomeric reactive diluent made of acrylic acid ester.

5. Method according to claim 1, wherein the viscosity of the radiation-curable printing ink at 20° C. and a shear rate of D=100 sec⁻¹ is less than 305 mPas, and the viscosity can be reduced to a value of less than 100 mPas (D=100 sec⁻¹) by tempering the printing cylinder up to 50° C.

6. Method according to claim 1, wherein the radiation curing is performed in an inert atmosphere.

7. Method according to claim 1, wherein the printing ink contains as low molecular weight binding agent one or more polyester acrylates, polyether acrylates including amino-modified types, or urethane acrylates with a molecular weight of less than 1500 and an acrylate functionality of at least 2.

8. Method according to claim 1, wherein the printing ink contains a polyester or a polyether acrylate including an amino-modified type thereof, an epoxy acrylate or a polyurethane acrylate with a molecular weight above 1500 and an acrylate functionality of at least 2, whereby the fraction of these substances accounts for max. 10% (w/w) of the sum of binding agent and pigment.

9. Method according to claim 1, wherein the binding agent of the printing ink contains one or more of the following monomers: HDDA, di- or tripropyleneglycol diacrylate (DPGDA, TPGDA), trimethylolpropane di- or triacrylate (TMPDA, TMPTA) including their ethoxylated or propoxylated derivatives, pentaerythriol triacrylate (PETIA) or pentaerythriol tetraacrylate (PETTA) including their ethoxylated or propoxylated derivatives, ditrimethylolpropane tetraacrylate (DiTMPTTA), tris(2-hydroxyethyl)-isocyanurate triacrylate (THEICTA) and triacrylated glycerol (GPTA).

10. Method according to claim 1, wherein the printing ink contains as vinyl ether essentially di-vinyl ethers and vinyl ethers of higher functionality.

11. Method according to claim 1, wherein the printing ink contains as vinyl ether monomeric vinyl ethers or hydroxyvinyl ethers.

12. Method according to claim 1, wherein the printing ink contains silanes at a fraction between 0.5 and 5% (w/w) as an additive to improve the adherence to plastic films or metal foils.

13. Method according to claim 12, wherein the printing ink contains one or more of the following silanes: 3-aminopropyltrimethoxysilane, 3-aminopropyltriethoxysilane, N-(n-butyl)-3-aminopropyltrimethoxysilane, polyglycolether-modified aminosilane, N-aminoethyl-3-aminopropylmethyldimethoxysilane, 3-aminopropylmethyl-diethoxysilane, 3-ureidopropyltriethoxysilane, N-aminoethyl-3-aminopropyltrimethoxysilane, triamino-functional propyltrimethoxysilane, 3-(4,5-dihydroimidazolyl)-propyltriethoxysilane, 3-methacryloxypropyltrimethoxysilane, 3-glycidyloxypropyltrimethoxysilane, 3-glycidyloxypropyltriethoxysilane, 3-mercaptopropyltrimethoxysilane, polyethersilane, vinyltrichlorosilane, vinyltrimethoxysilane, vinyltriethoxysilane, vinyltris(2-methoxyethoxy)silane.

14. Method according to claim 1, wherein the printing ink contains as a photoinitiator for the initiation of the radical polymerization one or more of the following compounds: 2-benzyl-2-dimethylamino-1-(4-morpholinophenyl)-butanone-1, phoshine oxides, in particular 2,4,6-trimethylbenzoyldiphenyl phosphine oxide, 2,4,6-trimethylbenzoylphenylethoxy phosphine oxide, bis(2,4,6-trimethylbenzoyl)-phenyl phosphine oxide, bis(2,6-dimethoxybenzoyl)-2,4,4-trimethyl-pentyl phosphine oxide, 1-hydroxy-cyclohexylphenylketone, 1-[4-(2-hydroxyethoxy)-phenyl]-2-hydroxy-2-methyl-1-propan-1-one, 2-hydroxy-2-methyl-1-phenylpropan-1-one, 1-hydroxycyclohexylphenylketone, 1-(4-isopropylphenyl)-2-hydroxy-2-methylpropan-1-one, 2-methyl-1-[4-(methylthio)phenyl]-2-morpholinopropanone-(1) or thioxanthone derivatives, in particular 2-isopropyl thioxanthone.

15. Method according to claim 14, wherein the printing ink contains derivatives as coinitiators.

16. Gravure printing ink printable in a rotogravure printing process, wherein the printing ink is curable by actinic radiation under polymerization of its binding agent and contains 20-75% (w/w) of an actinic radiation-curable binding agent system, 2-25% (w/w) of a vinyl ether, 0-45% (w/w) of a coloring agent, 2-15% (w/w) of a radical photoinitiator, and 0-10% (w/w) additives.

17. Gravure printing ink printable in a rotogravure printing process according to claim 16, wherein the binding agent of the printing ink contains one or more of the following monomers: pentaerythriol triacrylate (PETIA) including its ethoxylated or propoxylated derivatives, tris(2-hydroxyethyl)-isocyanurate triacrylate (THEICTA).

18. (canceled)

19. Gravure printing ink printable in a rotogravure printing process according to claim 16, wherein the printing ink contains silanes at a fraction between 0.5 and 5% (w/w) as an additive to improve the adherence to plastic films or metal foils.

20. Gravure printing ink printable in a rotogravure printing process according to claim 16, wherein the printing ink contains as a photoinitiator for the initiation of the radical polymerization one or more of the following compounds: 2-benzyl-2-dimethylamino-1-(4-morpholinophenyl)-butanone-1,2,4,6-trimethylbenzoylphenylethoxy phosphine oxide, 1-[4-(2-hydroxyethoxy)-phenyl]-2-hydroxy-2-methyl-1-propan-1-one.

21. Gravure printing ink printable in a rotogravure printing process according to claim 16, wherein the printing ink contains as a photoinitiator for the initiation of the radical polymerization one or several of the following compounds: phosphine oxides, bis(2,4,6-trimethylbenzoyl)-phenyl phosphine oxide, bis(2,6-dimethoxybenzoyl)-2,4,4-trimethyl-pentyl phosphine oxide, 1-hydroxycyclohexylphenylketone, 2-hydroxy-2-methyl-1-phenylpropan-1-one, 1-(4-isopropylphenyl)-2-hydroxy-2-methylpropan-1-one or thioxanthone derivates.

22-25. (canceled)

26. Substrate it is printed on by means of a printing method according claim 1.

27. Substrate it is printed on with a printing ink according to claim 16.

28. Gravure printing ink printable in a rotogravure printing process according to claim 16, wherein the printing ink contains as low molecular weight binding agent one or several polyester acrylates, polyether acrylates including amino-modified types, or urethane acrylates with a molecular weight of less than 1500 and an acrylate functionality of at least 2.
